(19) United States
(12) Patent Application Publication
(10) Pub. No.: US 2007/0276862 A1
(43) Pub. Date: Nov. 29, 2007

(54) Organizing and sharing digital content

(76) Inventor: Michael J. Toutonghi, Bellevue, WA (US)

Correspondence Address: HAHN AND MOODLEY, LLP, P.O. BOX 52050, MINNEAPOLIS, MN, 55402, US

(21) Appl. No.: 11/413,669

(22) Filed: Apr. 27, 2006

(51) Int. Cl. G06F 17/00

(52) U.S. Cl. 707/103 X

(57) ABSTRACT

In one embodiment a Content Management Service (CMS) is provided The CMS performs a method comprising receiving digital content data acquisition device; receiving a category for the digital content from the data acquisition device; storing the digital content, wherein the category is associated with the digital content; receiving a share-indication for the digital content from the data acquisition device; and upon the share-indication generating an encrypted link to the digital content; embedding the encrypted link in a message in accordance with the Short Message Service (SMS) protocol; and sending the SMS message to at least one invitee.

### FIELD OF THE INVENTION

Embodiments of the invention relate to organizing and sharing digital content.

### BACKGROUND

Today, increasingly there is a trend towards packing more features into the digital cameras of camera-enabled mobile phones and toward increasing the resolution and quality of such cameras. The result is that the people are taking more pictures with such cameras. The pictures taken with such cameras are typically stored on the mobile phone only temporarily as they are often moved from the camera to a remote storage location either on a user device such as a personal computer or on a server. Conveniently, the images may also be organized or categorized into collections as is described in co-pending U.S. patent application Ser. No. 11/302,566, which is hereby incorporated by reference. For example an image may be categorized into one or more named collections such for example a “2006 European Vacation” collection, a “My Children's Photos” collection, etc. to facilitate easy retrieval.

Co-pending U.S. patent application Ser. No. 10/817,599, which is hereby incorporated by reference discloses techniques to conveniently move the images from the mobile phone to their final storage location.

Besides images, other forms of digital content may be generated on a devices such as mobile phones, Pocket PCs, Personal Digital Assistants (PDAs), etc. Such content may include voice data, text documents, slides, etc. These other forms of digital content can also be categorized and moved to their final storage location using the techniques disclosed in U.S. patent applications Ser. No. 11/302,566 and U.S. Ser. No. 10/817,599.

Apart from personal use of digital content, increasingly the digital content is shared, for example, with friends, family, co-workers etc.

### SUMMARY OF THE INVENTION

In one aspect, the invention provides a method for organizing and sharing an image. For organizing the image, upon capturing the image with the built-in camera of a mobile phone, the image is sent to a collection on a remote storage location for storage thereon. For sharing the image, a link to the image is generated and sent to an invitee in the form of an invitation. Advantageously, the invitations are sent using the Short Message Service (SMS) protocol and include an encrypted link to the image.

Other aspects of the invention will be apparent from the detailed description below.

### BRIEF DESCRIPTION OF THE DRAWINGS

FIG. 1 shows a network environment within which embodiments of the invention may be practiced;

FIG. 2 shows a high-level block diagram of a Data Acquisition Device (DAD), in accordance with one embodiment of the invention;

FIG. 3 shows a flowchart of operations performed by the DAD of FIG. 2, in accordance with one embodiment of the invention;

FIG. 4 shows a flowchart of operations performed by Content Management Service (CMS) in accordance with one embodiment of the invention; and

FIG. 5 shows a high-level block diagram of hardware that for a server that may be used to implement the Content Management Service (CMS), in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Broadly, embodiments of the present invention disclose a method and system for organizing and sharing digital content. For the organization aspect, in one embodiment, content generated or captured by a data acquisition device (DAD) is sent or uploaded to a Content Management Service (CMS) or to a user storage device (USD). The Content Management Service (CMS) may be an online Content Management Service (CMS) and the USD may be any device that forms the final storage location for the content. As an example, the user storage device may be a personal computer (PC). The Content Management Service (CMS) stores the digital content and associates a category with the digital content. The category may define a virtual collection of like or similar digital content. For the sharing aspect, at the time of uploading the digital content to the Content Management Service (CMS), in one embodiment, a user is given the option of indicating whether the digital content is to be shared. For digital content that is to be shared, the Content Management Service (CMS) generates an encrypted link to the content. The encrypted link is embedded in an SMS message which is then sent to selected invitees who may then use the link to view the content. The invitees may be selected based on membership within a group which may be an ad hoc group created on the DAD for the purpose of sharing the newly generated digital content. Alternatively, the group may be a predefined group. Embodiments of the invention also cover a Content Management Service (CMS) that stores the digital content, associates the category with the digital content, generate the encrypted link, and sends the encrypted link via an SMS message to the selected invitees.

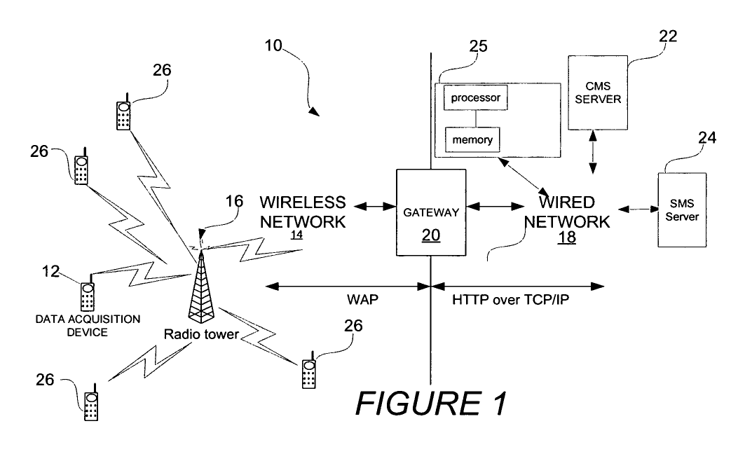

FIG. 1 shows a schematic drawing of a network environment 12 in which embodiments of the techniques described herein may be practiced. As shown in FIG. 1, a Data Acquisition Device (DAD) 12, such as for example a mobile telephone communicates with a wireless network 14 via a radio tower 16. The wireless network 14 may, for example, be a network such as a Mobile Digital Packet Data (MDPD) network, a Global System for Mobile (GSM) network, a Code Division Multiple Access (CDMA) network, or a Time Division Multiple Access (TDMA) network. The communications protocol used by the wireless network 14 includes the Wireless Application Protocol (WAP).

The wireless network 14 connects to a wired network 18, such as for example the Internet, via a Wireless Application Protocol (WAP) gateway 20. The gateway 20 serves to convert communications as they pass between the wireless network 14 and the wired network 18. One or more content management servers 22 (only one server 22 is shown in FIG. 1 of the drawings) for an online Content Management Service (CMS) (CMS) are connected to the wired network 18. The content management server 22 implements the Content Management Service (CMS). The CMS represents a service that is provided, for example on a subscription basis, to allow users to manage digital content. Thus, in one embodiment the CMS allows users to upload digital content to the servers 22 and to categorize the content into one or more categories or collections so that the content may be accessed at a later time by navigating through various collections. Examples of categories include a “My Wedding Photos” category, a “Children's Photos” category, a “Summer Vacation-2006” category, etc. The CMS also allows users to share the digital content via SMS messages as will be described later.

Also connected to the wired network 18 is a Short Message Service (SMS) server 24. The SMS server 22 includes functions to send SMS messages to mobile devices 26 that are coupled to the wireless network 14. The mobile devices represent any device capable of supporting wireless communications in accordance with the WAP protocol. Thus, for example, the mobile devices may include mobile phones, Personal Digital Assistants (PDAs), two way pagers, etc. Reference numeral 25 indicates a USD such as, for example, a PC that is couple to the wired network 18. As will be seen, the USD includes a processor and a memory couple to the processor. The memory may serve as the final storage location for content generated by the DAD 12.

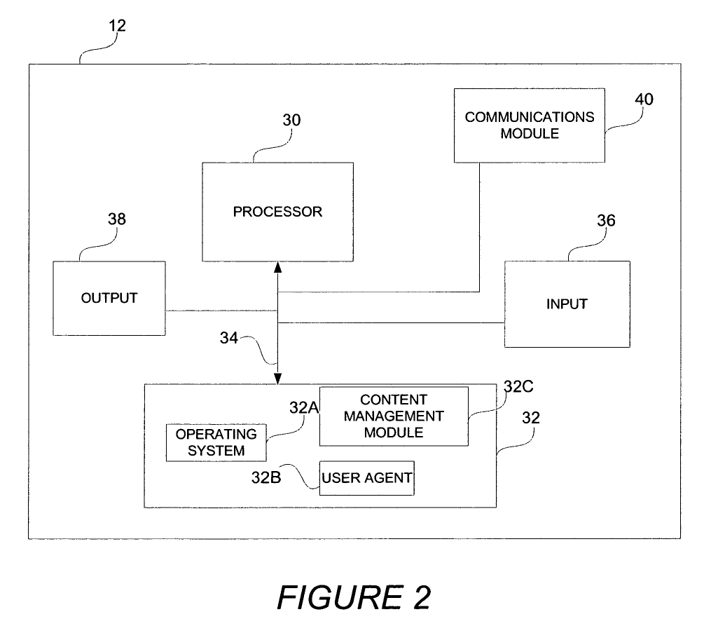

FIG. 2 of the drawings shows a high-level block diagram of the DAD 12, in accordance with one embodiment of the invention. As will be seen, the device 12 includes a microprocessor 30, which is coupled to a memory 32 via a communications path 34 which may include a bus. The DAD 12 also includes an input mechanism 36 and an output mechanism 38. According to different embodiments, the input mechanism 36 may comprise a keypad and/or a touch screen. The output mechanism 38 may comprise a display screen. Also coupled to the processor 30 is a communications module 40 which includes circuitry to enable the DAD 12 to communicate with the mobile devices 26 or with the servers 22. Thus, the communications module 40 includes circuitry to enable communications over the wireless network 14 as well as circuitry to enable communications over the wired network 18. The memory 32 may represent various memory technologies such as random access memory (RAM) devices, read only memory (ROM) devices, cache memory devices, etc. The memory devices that make up the memory module 32 may, in some embodiments, reside physically within other components of the DAD 12, e.g., within the processor 30. As will be understood by one skilled in the art, the memory 32 includes software components to enable operation of the DAD 12. Thus, for example, the memory 32 includes an operating system 32A, which provides an interface to the components of the DAD 12 to various application programs/software that run on the DAD 34. In accordance with one embodiment of the invention, the software includes a User Agent (UA) 32B to view web pages, and content management module 32C that enable the DAD 12 to upload and share digital content as will be described.

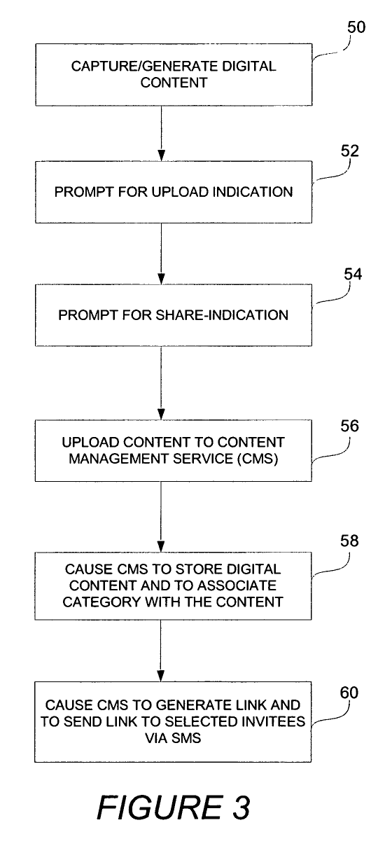

Referring now to FIG. 3 of the drawings, there is shown a flowchart of operations performed by the content management module 32 C, in accordance with one embodiment, in order to upload digital content to the content management server 22. As will be seen, at block 50 the DAD 12 generates or captures digital content. For example, in one embodiment, the DAD 12 may represent a camera-enabled phone and the digital content may in the form of a newly captured image. At block 52, a user of the DAD 12 is prompted to provide an upload indication. For example, once an image is captured the content management module 32C may cause an “upload button” to be displayed on a display screen of the DAD 12. Selection or activation of the upload button will cause the DAD 12 to upload the image to its final storage location. In one embodiment, the final storage location may be the USD 25. In another embodiment, the final storage location may be the server 22 of the CMS. The user may configure a default upload setting in the content management module 32C so that newly acquired digital content is automatically uploaded as described without the prompting step. At block 54, the user is prompted to indicate whether the content is to be shared. Said prompting may be achieved in different ways. For example, in one embodiment, in addition to the upload button described above a “upload and share button” may also be provided. Selection or activation of the upload and share button then provide a share indication to indicate to the content management module 32C that the content is to be shared. In one embodiment, the share indication may be implied for example when the user indicates that the content is to be categorized into a “shared” category. If sharing of the content is indicated, then in one embodiment the user is presented with a screen to allow the user to input or select contacts with whom the content is to be shared. The selection may be form a group of contacts, in one embodiment. In another embodiment, the selection may be by selection of a particular group of contacts so that sharing is with all contact in that group. To illustrate this aspect, consider the case where a use has predefined a “family” group and a “friends” group for his/her contacts. In response for input on the contacts with whom the content is to be shared, in one embodiment the user may select a whole group of contacts, for example the family and/or the friends group. Selection of a group results in sharing of the content with all contacts in that group. In one embodiment, the content management module 32A allows that user to create an ad hoc group, on the fly as it were, so that the content may be shared with contacts in the ad hoc group. For a new contact that is not saved in as address book, the content management module 32A allows the user to enter an SMS address for the new contact to allow sharing with that content. The user may be given that option of saving the new contact in the address book.

At block 56, the content is uploaded to the final storage location via the WAP gateway 20. Thus, if the final storage location is the USD 25, then the content is sent to the USD 25. This may be achieved via a peer-to-peer connection with the USD 25. If the final storage location is the server 22 then the content is sent to the server 22. At block 58, the content management module 32C causes the final storage location to associate one or more categories with the content. The block 58 includes sending categories to be associated with the content to the final storage location. In one embodiment, in order to obtain the categories, upon the capture or generation of the content, the content management module 32A prompts the user to input the categories. To facilitate rapid categorization, in one embodiment the content management module 32A may default to the last category that the user selected. The user is then given the option of accepting or changing the category. The categories may be sent together with the image at block 56.

At block 60 the content management module 32A causes the Content Management Service (CMS) to generate a link to the content and to send the link to the selected invitees. Causing the generation of the link, may be achieved in one embodiment by sending the share indication to the Content Management Service (CMS). For the embodiment where the final storage location is the USD 12, then the causing the generation of the link may include sending the share indication to the USD 12. The USD 12 then sends the content and the share indication to the CMS. In one embodiment the share indication is sent when the content is uploaded to the Content Management Service (CMS) at block 56. The share indication may be implied upon sending the user's selection or input of the contacts with whom the content is to be shared to the server 22, either directly or indirectly via the USD 12, as described. The user's selection or input of contacts may be sent to the final storage location together with the content at block 56.

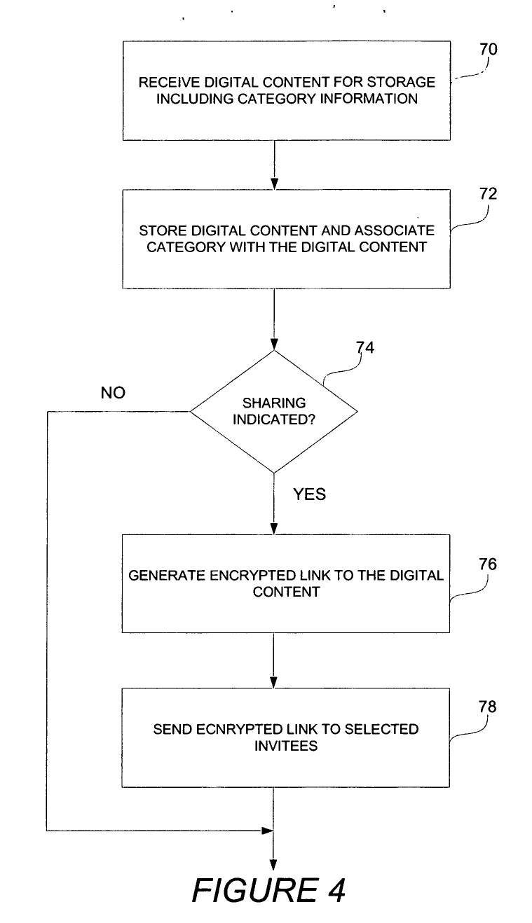

Turning now to FIG. 4 of the drawings, there is shown a flowchart of operations performed by the Content Management Service (CMS) in accordance with one embodiment of the invention. As will be seen, at block 70, the Content Management Service (CMS) receives the content from the DAD 12 directly, or via the USD 25. At block 70 the category to be associated with the content is also received from the DAD 12 or the USD 25. At block 72, the Content Management Service (CMS) stores the content and associates on or more categories with the content based on the categories received from the DAD 12, or the USD 25. At block 74 if sharing is indicated then control passes to block 76 and then to block 78, otherwise blocks 76 and 78 are skipped. As described above, sharing may be indicated by a share indication that is received from the DAD 12 or the USD 25. In some cases the share indication may be implied, for example when contacts or groups of contacts are received from the DAD 12 or the USD 25 thereby indicating to the Content Management Service (CMS) that the content is to be shared with the contacts. In one embodiment, at block 76, the Content Management Service (CMS) generates an encrypted link to the content. At block 68, the encrypted link is embedded in a Short Message Service (SMS) message which is sent to selected invitees defined by the selected contacts with whom sharing of the contact was indicated by the DAD 12 or the USD 25 The SMS messages are sent by the SMS server 24 via the WAP gateway 20 to the mobile devices 26 of the selected contacts. An invitee will thus receive that SMS message which serves as an invitation to access that content. By activating or selecting the link the mobile device 26 that received the SMS message will be able to establish a communications session with the server 22 and to access the content. The server 22 automatically authenticates the mobile device 26 based on the encrypted link, thus obviating the need to have the invitee enter authentication information and yet protecting the content from unauthorized access at the same time.

The foregoing described a technique whereby content acquired by a DAD 12 can be moved to its final storage location and then shared with selected invitees be having the server 22 generate and send SMS messages with a link to the content to the selected invitees. In one case the server 22 was the final storage location and thus the DAD 12 communicated directly with the server 22, as described. In another case, the USD 25 was the final storage location and in this case the DAD 12 communicated directly with the USD 25. For content to be shared, the USD 25 then communicated the content to the server 22 which in turn stored or replicated the content. The server 22 also generated and sent the SMS messages with the link to the content, as described. From the perspective of the USD 25, the USD 25 receives content from the DAD 12. The USD 25 also receives category information for the content from the DAD 12. In response to the receiving, the USD 25 stores the content and associates the content with one or more categories based on the category information. If a share indication was received from the DAD 12, then the USD 25 uploads the content to the server 22 along with the category information and the share indication. The server 22 stores the content, associates the one or more categories with the content, and generates and sends the SMS messages, as described.

In one embodiment of the invention, based on user input the DAD 12 may establish a communications session with the USD 25 for the purpose of browsing stored content on the USD 25. The user can then select content stored on the USD 25 to be shared with selected invitees. In response to the selection, the USD 25 uploads the selected content to the server 22 together with category information for the content and a share indication. The server 22 stores the content, associates one or more categories with the content, and generates and sends the above-described SMS messages to the selected invitees.

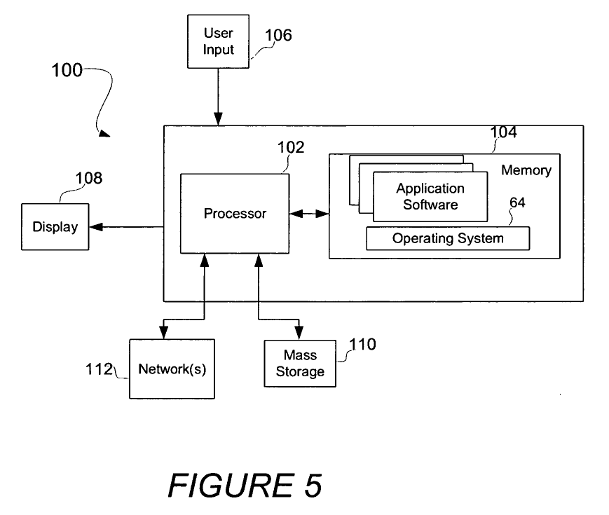

FIG. 5 of the drawings shows an example of hardware 100 that may be used to implement the server 22 in accordance with one embodiment of the invention. The hardware 100 typically includes at least one processor 102 coupled to a memory 104. The processor 102 may represent one or more processors (e.g., microprocessors), and the memory 104 may represent random access memory (RAM) devices comprising a main storage of the hardware 100, as well as any supplemental levels of memory e.g., cache memories, non-volatile or back-up memories (e.g. programmable or flash memories), read-only memories, etc. In addition, the memory 104 may be considered to include memory storage physically located elsewhere in the hardware 100, e.g. any cache memory in the processor 102 as well as any storage capacity used as a virtual memory, e.g., as stored on a mass storage device 110.

The hardware 100 also typically receives a number of inputs and outputs for communicating information externally. For interface with a user or operator, the hardware 100 may include one or more user input devices 106 (e.g., a keyboard, a mouse, etc.) and a display 108 (e.g., a Liquid Crystal Display (LCD) panel). For additional storage, the hardware 100 may also include one or more mass storage devices 110, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 100 may include an interface with one or more networks 112 (e.g., a local area network (LAN), a wide area network (WAN), a wireless network, and/or the Internet among others) to permit the communication of information with other computers coupled to the networks. It should be appreciated that the hardware 100 typically includes suitable analog and/or digital interfaces between the processor 102 and each of the components 104, 106, 108 and 112 as is well known in the art.

The hardware 100 operates under the control of an operating system 104, and executes various computer software applications, components, programs, objects, modules, etc. that define the Content Management Service (CMC) described above. Moreover, various applications, components, programs, objects, etc. may also execute on one or more processors in another computer coupled to the hardware 100 via a network 112, e.g. in a distributed computing environment, whereby the processing required to implement the functions of a computer program may be allocated to multiple computers over a network. In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure or the scope of the accompanying claims.

1. A method for organizing and sharing digital content generated by a device, comprising:
prompting a user for an upload-indication that controls if digital content generated by the device is to be sent to the Content Management Service (CMS);
upon the upload-indication, sending the digital content to the Content Management Service (CMS); and
causing the Content Management Service (CMS) to store the digital content in a category for the digital content; and
causing the Content Management Service (CMS) to generate a link to the digital content and to send the link in the form of a message based on the Short Message Service (SMS) protocol to selected invitees.

2. The method of claim 1, wherein causing the Content Management Service (CMS) to generate the link comprises prompting the user for a share-indication as to whether the digital content is to be shared with the selected invitees, receiving the share-indication from the user; and sending the share-indication to the Content Management Service (CMS).

3. The method of claim 2, wherein the share-indication is an implied indication received when the user selects the selected invitees.

4. The method of claim 3, further comprising allowing the user to select the selected invitees by selecting a group of contacts that the selected invitees belong to.

5. The method of claim 4, further comprising allowing the user to generate the group of contacts as an ad-hoc group.

6. The method of claim 2, wherein the share-indication is sent to the CMS via a user storage device.

7. The method of claim 1, wherein causing the Content Management Service (CMS) to store the digital content in a category defined for the digital content comprises prompting the user for the category; receiving the category; and sending the category to the Content Management Service (CMS).

8. A method for a Content Management Service (CMS), comprising:
receiving digital content from a device;
receiving a category for the digital content from the device;
storing the digital content, wherein the category is associated with the digital content;
receiving a share-indication for the digital content from the device;
upon the share-indication generating an encrypted link to the digital content; embedding the encrypted link in a message in accordance with the Short Message Service (SMS) protocol; and sending the SMS message to at least one invitee.

9. The method of claim 8, wherein the digital content, the category; and
the share-indication are part of a single transmission from the device.

10. The method of claim 8, wherein, upon receiving the encrypted link from the invitee, allowing the invitee to access the digital content.

11. The method of claim 8, further comprising determining the at least one invitee based on membership in a group of contacts.

12. The method of claim 11, wherein the share-indication comprises the group.

13. A data acquisition device, comprising:
a processor; and
a memory coupled to the processor, the memory storing instructions which when executed by the processor cause the processor to perform a method comprising:
prompting a user for an upload-indication that controls if digital content generated by the device is to be sent to the Content Management Service (CMS);
upon the upload-indication, sending the digital content to the Content Management Service (CMS); and
causing the Content Management Service (CMS) to store the digital content in a category for the digital content; and
causing the Content Management Service (CMS) to generate a link to the digital content and to send the link in the form of a message based on the Short Message Service (SMS) protocol to selected invitees.

14. A server, comprising:
a processor; and
a memory coupled to the processor, the memory storing instructions which when executed by the processor cause the server to perform a method comprising:
receiving digital content from a device;
receiving a category for the digital content from the device;
storing the digital content, wherein the category is associated with the digital content;
receiving a share-indication for the digital content from the device;
upon the share-indication generating an encrypted link to the digital content; embedding the encrypted link in a message in accordance with the Short Message Service (SMS) protocol; and sending the SMS message to at least one invitee.

15. A machine-readable medium, having stored thereon a sequence of instructions which when executed by a processor for a server, cause the server to perform a method comprising:
receiving digital content from a device;
receiving a category for the digital content from the device;
storing the digital content, wherein the category is associated with the digital content;
receiving a share-indication for the digital content from the device;
upon the share-indication generating an encrypted link to the digital content; embedding the encrypted link in a message in accordance with the Short Message Service (SMS) protocol; and sending the SMS message to at least one invitee.

16. The machine-readable medium of claim 15, wherein, upon receiving the encrypted link from the invitee, the method comprises allowing the invitee to access the digital content.

17. The machine-readable medium of claim 15, wherein the digital content, the category; and the share-indication are part of a single transmission from the device.

18. The machine-readable medium of claim 15, wherein, upon receiving the encrypted link from the invitee, the method comprises allowing the invitee to access the digital content.

19. The machine-readable medium of claim 15, wherein the method further comprises determining the at least one invitee based on membership in a group of contacts

20. The machine-readable medium of claim 19, wherein the share-indication comprises the group.
